(19) United States
(12) Patent Application Publication
(10) Pub. No.: US 2026/0217263 A1
(43) Pub. Date: Jul. 30, 2026

(54) A Method And System For Correcting A Self-Describing Dataset Of An Ego-Vehicle, Computer Program Product And Computer Readable Medium For Implementing The Method

(71) Applicant: Commsignia Kft., Attala (HU)

(72) Inventors: Gergely György Regula, Budapest (HU); András Váradi, Budapest (HU); Gábor Rödönyi, Isaszeg (HU); Gergely Attila, Gyál (HU)

(21) Appl. No.: 19/141,388

(22) PCT Filed: Dec. 22, 2023
(86) PCT No.: PCT/HU2023/050097

§ 371 Date: Jun. 20, 2025

(30) Foreign Application Priority Data
Dec. 22, 2022 (HU) P2300002

(51) Int. Cl. B60W 50/02; H04W 4/40

(52) U.S. Cl. CPC B60W 50/02; H04W 4/40; B60W 2556/45; B60W 2756/10

(57) ABSTRACT

The invention relates to method for correcting a self-describing dataset of an ego-vehicle, wherein the self-describing dataset comprises parameter values of the ego-vehicle's vehicle parameters and/or vehicle states, the method comprising
a data collection step including
   receiving, by the ego vehicle, a message from an other entity, and
   extracting, by the ego-vehicle, ego-vehicle related data from the message, wherein the extracted ego-vehicle related data includes at least one parameter value of any one of the ego-vehicle's vehicle parameters and/or vehicle states,
a data verification step including
   determining, by the ego-vehicle, a reliability score of the extracted ego-vehicle related data, and
   if the reliability score of the extracted ego-vehicle related data is above a predetermined reliability threshold, comparing the extracted ego-vehicle related data with a corresponding parameter value of the self-describing dataset, and if the corresponding parameter value of the self-image is incorrect, updating, in a parameter updating step, the corresponding parameter value of the self-describing dataset with the extracted ego-vehicle related data.

The invention further relates to a system, a computer program product and a computer readable medium for implementing the method. (FIG. 2)

### TECHNICAL FIELD

The invention relates to a method and system for correcting a self-describing dataset of an ego-vehicle, wherein the self-describing dataset comprises parameter values of the ego-vehicle's vehicle parameters and/or vehicle states. The invention relates also to a computer program product and computer readable medium implementing the method.

In ground transport the improvement of communication technologies allows entities to share and receive various types of information. An example is a vehicle-to-everything (V2X) technology that allows sharing of information in a distributed manner preferably via standardised message formats in real-time over dedicated radio channels. The main objective is to enhance traffic safety. In recent times, the penetration of V2X-enabled devices has dynamically increased and the rate of the spread of technology is expected to further increase. The final aim is to integrate each relevant participant, including pedestrians, cyclists, or e-scooter users, which further enhances road safety.

Communication between traffic participants and infrastructure elements can also be achieved by infrastructure-to-everything (I2X) technology. I2X technology is quite similar to V2X, but represents the communication from the infrastructure elements such as Road Side Units (RSU) to the road users. The direction from the road users to the infrastructure is covered by V2X technology, which means that the infrastructure elements can also receive V2X messages. To achieve the objective of integrating relevant participants, an increasing number of roadside units (RSUs) have started to be equipped with smart sensors that usually perform object detection and tracking as well, which can serve as an input to dedicated sensor sharing messages (e.g. the Collective Perception Message in European and the Sensor Data Sharing Message in the US regions). Furthermore, as most vehicles are equipped with several sensors having various safety functions, their detections may also be shared within these standardized messages, providing the V2X participants with an enormous amount of information. The information shared via V2X messages can be used for e.g. sensor fusion or even map-matching.

### BACKGROUND ART

When a V2X-enabled entity has an error or malfunction, V2X messages can be used for sharing or receiving related information.

US 2023/0045241 A1 discloses a system and method for remote observation and reporting of vehicle operating condition via V2X communication. The document discloses that sometimes a vehicle might not be aware of some of its operating conditions, e.g. some malfunctions. The document proposes to use a first vehicle as an observer to observe a second vehicle (target vehicle). The observer vehicle transmits the observed information via V2X communication. Crowd-sensing or a cross-domain sanity check is possible, and the target vehicle can filter and synthesize different information from different observer vehicles for a more trustable consensus. The disadvantage of such a solution is that an ego-vehicle (target vehicle) needs to rely on information processed and transmitted by a different entity. If the observer vehicle has malicious intent or if it is hacked, false information might be communicated to the target vehicle.

U.S. Pat. No. 11,354,951 B2 discloses a method for diagnosing an error of an ego-vehicle and/or a surrounding vehicle. The ego-vehicle receives sensor data and also transmitted data from other vehicles. The ego-vehicle compares the sensor data with the received data, and if a difference is detected, a potential error of the ego-vehicle or the other vehicle can be registered, and the potential error can be reported e.g., as a V2V message.

CN 114611785 A discloses a V2X-oriented cooperative vehicle data correction method, wherein a vehicle collects its own driving state information and sends the driving state information to an RSU, the vehicle predicts driving state data and makes plausibilization of the collected driving state according to the prediction results and corrects unreasonable data. The RSU can judge plausibility of the received driving state information and return a plausibility judgement and corrected driving state information to the original vehicle, then the vehicle can obtain a cooperatively corrected driving state information of the vehicle.

In view of the known approaches, there is a need for a method that allows an ego-vehicle to correct or update its own parameter values, e.g., parameter values of their vehicle parameters and/or vehicle states.

### DESCRIPTION OF THE INVENTION

The primary object of the invention is to provide a method for correcting a self-describing dataset of an ego-vehicle, which is free of the disadvantages of prior art approaches to the greatest possible extent.

As it is indicated above, most of the known methods highly rely on pre-processed error messages received from other entities, which can make an ego-vehicle vulnerable to malicious attacks.

A further object of the invention is to provide a method and also a system that allows an ego-vehicle to correct its own self-describing dataset, i.e., data describing any one or all of the ego-vehicle, its operation condition and/or vehicle state.

Furthermore, the object of the invention is to provide a non-transitory computer program product for implementing the steps of the method according to the invention on one or more computers and a non-transitory computer readable medium comprising instructions for carrying out the steps of the method on one or more computers.

The objects of the invention can be achieved by the method according to claim 1. The objects of the invention can be further achieved by the system according to claim 10, the non-transitory computer program product according to claim 18, and by the non-transitory computer readable medium according to claim 19. Preferred embodiments of the invention are defined in the dependent claims.

An advantage of the method according to the invention is that an ego-vehicle on its own can deduct that one or more of its known data is incorrect or outdated and it can correct or update it on its own. Therefore, the ego-vehicle can utilize general V2X messages, 12X messages and/or perception messages to get more information about its own vehicle parameters, operational conditions or vehicle state.

It has been recognized that general V2X or similar messages can contain important information about the ego-vehicle, and this information can be used to enhance the ego-vehicle's knowledge about its own characteristics.

In certain embodiments of the method according to the invention, information gathered from infrastructure elements are also used. The advantage of infrastructure-based information is that the infrastructure elements usually have a fixed position, and typically their sensors are also located at a higher position. Due to these circumstances, measurement or sensor data originating from an infrastructure element, e.g., a road-side unit (RSU), can have a higher reliability.

### BRIEF DESCRIPTION OF THE DRAWINGS

Preferred embodiments of the invention are described below by way of example with reference to the following drawings, where

FIG. 1 is an exemplary block diagram of an internal structure of a V2X communication unit that is adapted for implementing a preferred embodiment of the method according to the invention,

FIG. 2 is a block diagram of a preferred embodiment of a self-reflection unit performing one or more steps of the method according to the invention.

FIGS. 3A-3C show sequence diagrams of exemplary implementations of the method according to the invention, and FIGS. 4A-4B show exemplary use cases of the method according to the invention.

### MODES FOR CARRYING OUT THE INVENTION

The invention relates to a method for correcting a self-describing dataset of an ego-vehicle, wherein the self-describing dataset comprises parameter values of the ego-vehicle's vehicle parameters and/or vehicle states. As an example, one or more of the following parameters or variables can be included in the self-describing dataset:
parameters important in safety applications (e.g., size, weight, colour),
parameters with diagnostic relevance (e.g., visibility of lights, licence plate, tire conditions),
parameters representing safety status (e.g., state of the safety belt, presence of baby seat, safety helmet of a cyclist),
slowly varying parameters (e.g., an occupied lane),
position of a road-side unit.

The above listed parameters have the common characteristics that they require special attention and therefore classical estimation methods must be applied with care. Either because of the rare and limited availability of (good quality) measurements, or the unlikeliness of parameter change and the sensitivity of safety applications on the parameter: strong evidence on the quality of the potential parameter update or correction is required.

The goal of the invention is to provide a generic solution for updating or correcting an ego-vehicle's knowledge about approximately constant parameters and/or slowly or rarely varying variables.

The method according to the invention comprises at least a data collection step and a data verification step. In the data collection step, a message is received from an other entity, and ego-vehicle related data is extracted from the message by the ego-vehicle. The extracted ego-vehicle related data includes at least one parameter value of any one of the ego-vehicle's vehicle parameters and/or vehicle states. In a preferred embodiment of the method according to the invention, messages can be received by the ego-vehicle from one or more other entities. Preferably, the other entity is an infrastructure entity, such as a road-side unit.

In the data verification step, the ego-vehicle determines a reliability score of the extracted ego-vehicle related data, and if the reliability score of the extracted ego-vehicle related data is above a predetermined reliability threshold, the ego-vehicle compares it with a corresponding parameter value of the self-describing dataset. If the corresponding parameter value of the self-image seems to be incorrect, then the ego-vehicle can, in a parameter updating step, update the corresponding parameter value of the self-describing dataset with the extracted ego-vehicle related data.

If, in the data collection step, messages are received from one or more other entities, in the data verification step preferably said messages are considered for determining the reliability score. The messages can be V2X messages and/or I2X messages.

As a reliability threshold, for example, a given number of occurrences needs to be reached, preferably within a given period of time. For example, a reliability score threshold can be set to five consecutive detections, i.e., receiving a same or similar parameter value for a parameter five times in a row from the same or different other entities. In cases, when the same information or message has been received more than one other entities, the reliability score can be increased accordingly.

As a reliability threshold, for example, a ratio of occurrences can also be used, e.g., a data can be found reliable, if at least 60% or 80% of the received messages confirm the same parameter. The reliability threshold is preferably determined based on the importance of a given parameter. E.g., knowing the right colour of an ego-vehicle can be less critical than not knowing the right size of the ego-vehicle.

In a preferred embodiment of the method, the verification step further includes a scene analysing step, preferably performed by a scene analyser unit, for analysing measurement conditions and a result of the scene analysing step is considered for the determination of the reliability score. As an example, the measurement conditions can include at least one of the following: a sensor type, a view angle, a weather condition, a visibility condition, a relative position of the ego-vehicle and the other entity, and an occlusion possibility.

In a preferred embodiment of the method, the ego-vehicle can send a message to the other entity comprising a parameter value of the self-describing dataset and request to sending back a return message comprising information in connection with the sent parameter value of the self-describing dataset.

The extracted ego-vehicle related data is preferably stored in a database. In a preferred embodiment of the method, only extracted data having a quality indicator value above a predetermined threshold is stored in the database. The latter can help to improve the efficiency of the method, because it is not necessary to deal with data that is not reliable enough.

The invention also relates to a system for correcting a self-describing dataset (e.g., a “self-image”) of an ego-vehicle. The system according to the invention preferably comprises an ego-vehicle implementing the method according to the invention, and an other entity adapted to send a message to the ego-vehicle. The other entity is preferably an infrastructure entity, such as a road-side unit.

The ego-vehicle preferably comprises a communication unit for receiving a message from the other entity. Furthermore, the ego-vehicle preferably comprises a data extraction unit for extracting ego-vehicle related data from the message, wherein the extracted ego-vehicle related data includes at least one parameter value of any one of the ego-vehicle's vehicle parameters and/or vehicle states. The vehicle parameters or vehicle states can be any parameter or variable that relates to any Information or feature of the ego-vehicle.

Preferably, the ego-vehicle comprises a verification unit connected to the data extraction unit, wherein the verification unit is configured to determine a reliability score of the extracted ego-vehicle related data.

Furthermore, the ego-vehicle preferably comprises a scene analyser unit for analysing measurement conditions, wherein an output of the scene analysing unit is fed to the verification unit to be considered for the determination of the reliability score. The measurement conditions preferably include at least one of the following: a sensor type, a view angle, a weather condition, a visibility condition, a relative position of the ego-vehicle and the other entity, and an occlusion possibility.

The message exchanged between the ego-vehicle and the other entity is preferably a V2X message or an I2X message.

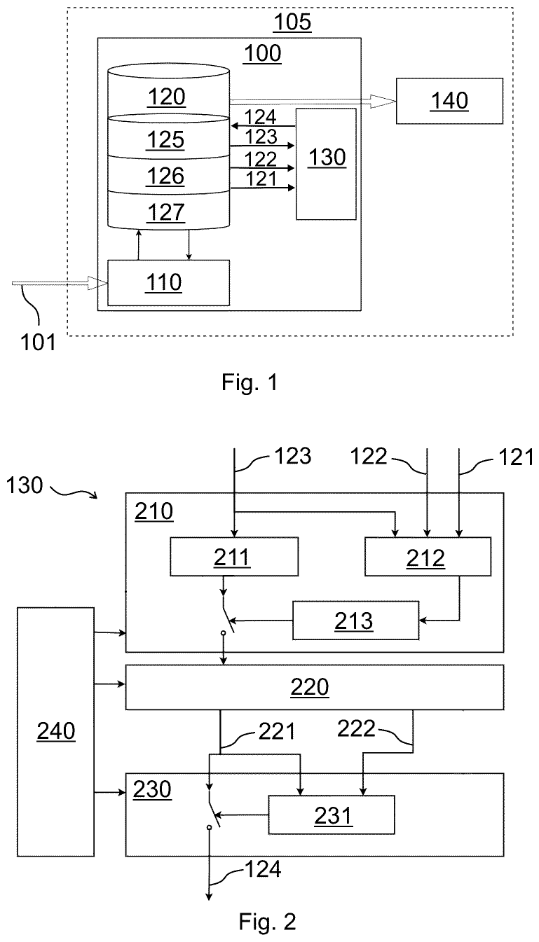

FIG. 1 shows an exemplary block diagram of an internal structure of a V2X communication unit 105 that is adapted for implementing the method according to the invention. The V2X communication unit 105 preferably receives incoming data 101, wherein the incoming data 101 is preferably a V2X message, an other type of message, or local sensor data. Preferably the incoming data 101 or a relevant content of the incoming data 101 is analysed and then preferably stored in a database 120 which is preferably an internal database of the V2X communication unit 105. The database 120 preferably has a structure for efficient data storage and quick access, therefore other services 140, e.g., a Cooperative Awareness Service or a Basic Safety Service, or any other service that can reside in the so-called Facilities Layer of a Cooperative Intelligent Transport Systems (C-ITS), or any higher-level application depending on such services, can utilise the data stored in the database 120.

Entities being in a communication connection with an ego-vehicle usually give a report on themselves e.g., in a form of a message such as a Cooperative Awareness Message (CAM) or a Basic Safety Message (BSM), or an entity can detect and report other entities, e.g., in a form of a Collective Perception Message (CPM) or a Sensor Data Sharing Message (SDSM). Preferably, the database 120 manages and stores data from any type of messages or sensors. Even more preferably, the database 120 also tracks entities, of which data is stored in the database 120.

To aid the work of the database 120, the V2X communication unit 105 preferably comprises a data association unit 110, which is preferably adapted to associate an incoming object detection (e.g., information about a detected object) or an entity trajectory with information already stored or managed in the database 120. Preferably, the database 120 is configured to store only data relevant for the ego-vehicle, which allows a more efficient allocation of computational resources.

The data association unit 110 can implement a sensor fusion algorithm or a map-matching algorithm or any other algorithm that can help to better associate an incoming data 101 with an object or any already stored information in the database 120. Such a data association unit 110 makes it possible, that without any external help, the ego-vehicle could subscribe for object detections received in CPM or SDSM messages that represent measurements related to the ego-vehicle taken by other entities such as other vehicles or road-side units.

Because the data association unit 110 is a part of the V2X communication unit 105, the invention does not rely on V2X messages that are specifically targeted for the ego-vehicle. The data association unit 110 is supposed to detect information that is related to the ego-vehicle in any broadcast style object information sharing message type (like CPM, SDSM). Therefore, direct perception data, or the result of any sensor fusion algorithm can be a source of information that is then sent via a viable V2X message (e.g., CPM, SDSM) for the ego-vehicle.

The data association unit 110 is preferably configured to feed the database 120 with already associated data, therefore the database 120 can store the data received from the data association unit 110 with respective of its data type. Preferably, the database 120 stores data associated with the ego-vehicle (ego-data 123), data associated with an infrastructure entity (infrastructure data 122) and data associated with a remote entity (remote data 121). These types of data stored by the database 120 are introduced in more detail below. Preferably, ego-data 123 is stored in an ego-storage 125, while infrastructure data 122 and/or remote data 121 is stored in a remote-storage 126. The database 120 can also store map-data separately in a map-storage 127 that can also be accessed by the data association unit 110.

The ego-data 123 preferably contains perception information about the ego-vehicle that has been detected by sensors of infrastructure entities (e.g. road-side units with object detection capability) and stored ego-vehicle parameters. Furthermore, other entities such as other vehicles can provide perception information about the ego-vehicle, which information can also be stored in the database 120 as ego-data 123. The ego-data 123 may include measurement data or estimated values, or other data derived from incoming data 101.

Infrastructure data 122 preferably comprises position and orientation information about the infrastructure entity (e.g., an RSU) which has sent a perception message about the ego-vehicle. The perception message preferably contains aggregated data about the ego-vehicle that is a result of e.g., any sensor fusion algorithm or procedure. For each ego-data 123, a corresponding infrastructure data 122 can be accessed from the database 120.

Remote data 121 preferably contains data for a list of relevant remote entities in a neighbourhood of ego-vehicle, that can preferably also can potentially obstruct the sensing of the infrastructure element.

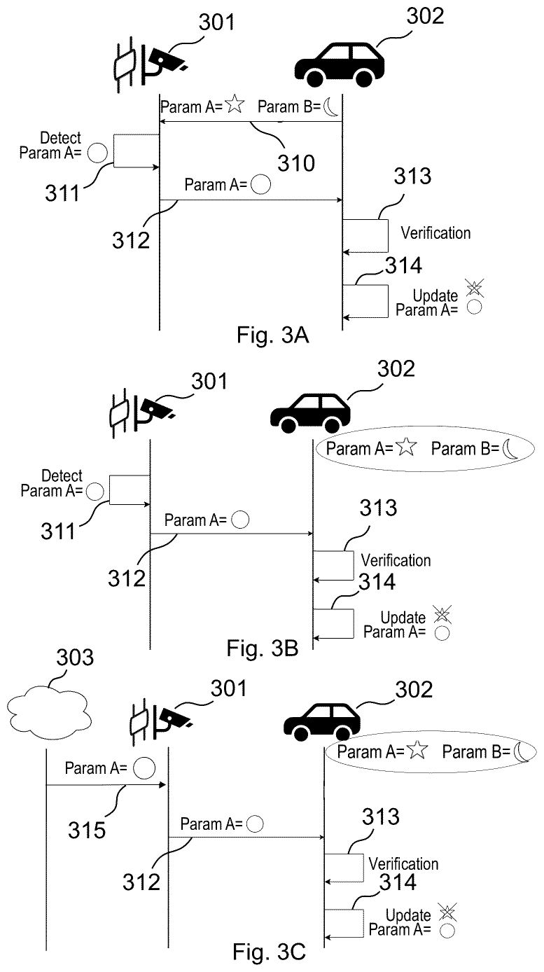

The V2X communication unit 105 furthermore comprises a self-reflection unit 130 that is in connection with the database 120 to exchange data. The self-reflection unit is adapted to perform one or more steps of the method according to the invention. The self-reflection unit 130 is introduced in more detail in FIG. 2, showing a block diagram of a preferred embodiment of the self-reflection unit 130.

Preferably, the self-reflection unit 130 has access to the ego-data 123, infrastructure data 122 and remote data 121. Preferably, the self-reflection unit 130 processes this information as described in connection with FIG. 2 later, and produces a parameter update 124. The parameter update 124 is a new value to be stored for a targeted parameter or variable of the ego-vehicle.

FIG. 2 shows a block diagram of a preferred embodiment of the self-reflection unit 130 performing one or more steps of the method according to the invention. The self-reflection unit 130 is preferably adapted to continuously monitor how other entities such as infrastructure entities see an ego-vehicle, and to compare these observations (“reflections”) with a “self-image” of the ego-vehicle, i.e., as the ego-vehicle “sees” itself. The “self-image” is therefore a self-describing dataset of the ego-vehicle that has e.g., internally stored parameters and variables of the ego-vehicle along with their respective values. The self-reflection unit 130 preferably carefully examines, reviews and possibly updates the self-image, if a previously incorrect parameter or parameter value has been found.

For different parameters or variables, the self-reflection unit 130 preferably uses different methods and/or algorithms to validate a correctness of a known (stored) value or parameter and/or a new incoming data. For example, for static parameters that do not change over time or change very rarely (such as a length of a vehicle, a colour, etc.), and for variables or dynamic parameters that might change more frequently (like map-matching results, e.g., which lane the ego-vehicle is currently using) different approaches are necessary for validation, estimation and/or update. Preferably, different types of parameters, variable, vehicle states are examined and evaluated independently. Thus, FIG. 2 shows a general scheme only.

The self-reflection unit 130 preferably includes a data prefilter module 210 that is preferably adapted to check the reliability and accuracy of any received information. More preferably, the data prefilter module 210 is adapted to check the reliability and accuracy of specific parameters. If a received information is deemed unreliable or incorrect, it is discarded, therefore only reliable and accurate (i.e., high-quality) measurements are stored for further processing, which enhances the performance of the method according to the invention.

Preferably, data prefilter module 210 has a parameter selection module 211 that receives ego-data 123 (e.g., from the database 120 of FIG. 1) and searches information relevant to any of the self-describing dataset.

The data prefilter module 210 preferably further includes a first decision-making unit 213 that is adapted to make a decision on whether an ego-data 123 is worth keeping for further processing.

Optionally, the data prefilter module 210 has a scene analyser unit 212. The scene analyser unit 212 preferably receives remote data 121 and/or infrastructure data 122, as well as ego-data 123. Based on these data, e.g., based on a relative position of an observing entity providing the ego-data 123 and the ego-vehicle itself, the scene analyser unit 212 can reconstruct the scene at the time of the observation and can decide whether the observing entity had a chance to take a good quality measurement on the ego-vehicle. The scene analyser unit 212 preferably examines the perspective from which a measurement is taken, e.g., a relative distance, an angle of view, but other relevant limiting conditions may also be checked, such as weather and light conditions. The scene analyser unit 212 can also uses a location of any neighbouring entity to examine a possibility of an occlusion which could prevent a high-quality detection or may even mislead the observing entity. For example, partially occluding objects may be detected erroneously as one single object by a visual sensor.

The scene analyser unit 212 preferably also relies on an information accuracy provided by a sensor of an RSU to evaluate the quality of the measurement. The scene analyser unit 212 is a component that can help ensuring that an incoming observed data is correct and reliable. The scene analyser unit 212 is preferably provides an input for the first decision-making unit 213 for an established decision whether to keep or discard the ego-data 123 under examination.

As it would be dangerous to update or correct an element of the self-describing dataset just because a given number of conflicting information has been received, as these can be unfounded or a malicious attack to make the ego-vehicle believe an incorrect information. The scene analyser unit 212 can contribute that only reliable ego-data 123 are analysed further.

The first decision-making unit 213 preferably only allows a use of a measurement (an ego-data 123) in a subsequent process if the measurement and the observation conditions pass a reliability, accuracy and plausibility tests. These tests can vary for different parameters or variables.

Preferably, the first decision-making unit 213 is connected to a configuration module 240, and the configuration module 240 provides the information and algorithms to the data prefilter module 210 to be used in connection with a given parameter or variable. The configuration module 240 preferably contain and share information about tolerances and thresholds to be used by elements of the self-reflection unit 130, e.g., by the parameter selection module 211 and/or by the first decision-making unit 213.

Configuration parameters stored and distributed by the configuration module 240 allow for scaling of a generic self-reflection algorithm to a sampling rate of the measurements and a time-scale of the parameter variation. For example, for a time-varying variable with a higher rate of change (bandwidth), the data prefilter module 210 and a quality checker module 230 (see later) can be configured to enable more data transfer and faster parameter updates.

Ego-data 123 that passes the data prefilter module 210, i.e., is deemed reliable enough for further processing is preferably fed to a parameter estimation module 220.

Reliable, plausible and sufficiently accurate measurements delivered by the data prefilter module 210 are handled by the parameter estimation module 220. The parameter estimation module 220 collects and analyses incoming measurements and preferably provides a parameter estimate 221 together with a quality indicator value 222. The quality indicator value 222 preferably depends on a number of incoming measurements and their consistency. Depending on the type of a targeted parameter (e.g., an element of the self-describing dataset), the parameter estimation module 220 uses different approaches, e.g., a Bayesian estimation or filtering, a Hidden Markov Model, a Multiple Model approach, a sensor fusion method, or simply computing the number of consistent measurements. Preferably the configuration module 240 provides input or instruction to the parameter estimation module 220 what type of approach to be used, preferably based on the target parameter in question. The parameter estimation module 220 can further assist filtering out of uncertain incoming perception data, even if a source of data (e.g., an RSU) was considered reliable by the data prefilter module 210.

The self-reflection unit 130 preferably further includes a quality checker module 230 that preferably performs a validation step regarding the entire estimation process. It allows an update of a parameter by the parameter estimate 221 according to a decision of a second decision-making unit 231.

Preferably, an output of the parameter estimation module 220 is monitored by the second decision-making unit 231. If a sufficient amount of reliable observation (reflection) contradicts a current ego-parameter (an element of the self-describing dataset) and no or too few observations confirm that ego-parameter, the second decision-making unit 231 may initiate an update of the self-describing dataset by the parameter update 124. The correct parameter value will be stored in the database 120.

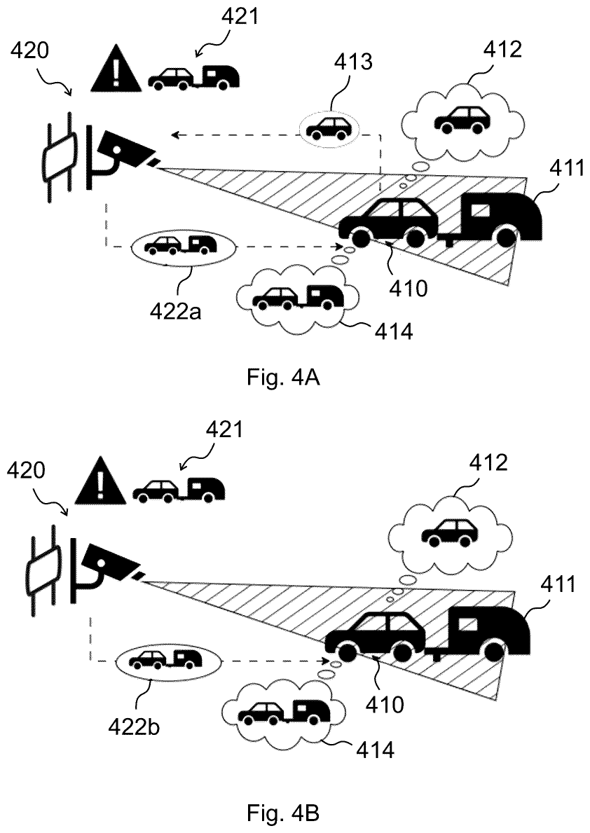

FIGS. 3A-3C show sequence diagrams of three exemplary implementations of the method according to the invention.

According to the example (use case) of FIG. 3A, an ego-vehicle 302 shares or broadcasts a message 310 containing at least part of its own self-describing dataset. In the depicted example, the ego-vehicle 302 shares a message 310 containing a subset of the self-describing dataset of the ego-vehicle 302, i.e., two parameters (Parameter A and Parameter B) and their respective parameter values of the self-describing dataset of the ego-vehicle 302, wherein the parameter value of Parameter A is depicted by a star and the parameter value of Parameter B is depicted by a crescent moon. The message 310 is received by a road-side unit 301 that is equipped with one or more sensors, that can detect one or more parameter values of the ego-vehicle 302. In the example, the road-side unit 301 is equipped with a camera and it can detect in a detection step 311 a parameter value of Parameter A of the ego-vehicle 302. According to the example, the road-side unit 301 detects a different parameter value for Parameter A of the ego-vehicle 302, wherein the detected parameter value is depicted by a circle. The road-side unit 301 then sends a perception message 312 (e.g., an I2X message) containing a detected parameter value of Parameter A to the ego-vehicle 302. The ego-vehicle 302 performs verification of the detected parameter value received from the road-side unit 301 in a verification step 313. In this verification step 313 preferably a self-reflecting procedure is performed, e.g., a same or a similar procedure to the one described in connection with FIG. 2. If the detected parameter value received from the road-side unit 301 seems to be correct, i.e., it is verified, then in an updating step 314, the ego-vehicle 302 updates its self-describing dataset, i.e., updates the parameter value of Parameter A in the self-describing dataset to the one received from the road-side unit 301.

FIG. 3B shows a sequence diagram similar to the one shown in FIG. 3A with only a slight difference, i.e., that the ego-vehicle 302 does not share or broadcast one or more parameter values of its self-describing dataset. According to FIG. 3B, the ego-vehicle has a same initial self-describing dataset as in FIG. 3A. A road-side unit 301 has or connected to one or more sensors, therefore it is capable to detect at least one parameter value of at least one parameter of the ego-vehicle 302. In FIG. 3B the road-side unit 301 is equipped with a camera and it is also capable of detecting a parameter value of Parameter A of the ego-vehicle 302. In a detection step 311, the road-side unit 301 detects the parameter value (depicted by a circle) of Parameter A of the ego-vehicle, and sends or broadcasts a perception message perception message 312 (e.g., an I2X message) containing the detected parameter value of Parameter A. When the ego-vehicle 302 receives the perception message 312 and confirms that this message 312 contains information about itself, it can verify the received information in a verification step 313. In this verification step 313 preferably a self-reflecting procedure is performed, e.g., a same or a similar procedure to the one described in connection with FIG. 2. If the received information seems to be correct, the ego-vehicle 302 can correct or update its self-describing dataset in an updating step 314.

FIG. 3C shows a further sequence diagram, wherein a road-side unit 301 is connected to a cloud server 303. The cloud server 303 preferably has a series of data (e.g., time series data) about the ego-vehicle 302, then an appropriate logic of the cloud server 303 can deduct one or more parameters of the ego-vehicle 302. The cloud server 303 can send an instruction 315 or a message to the road-side unit 301 to communicate the one or more parameters to the ego-vehicle 302. According to the example of FIG. 3C, the cloud server 303 has the information about a parameter value of Parameter A of the ego-vehicle 302. When the road-side unit 301 receives information about the ego-vehicle 302, the road-side unit 301 send a perception message 312 containing said information to the ego-vehicle 302, just like in FIGS. 3A and 3B. The further steps of the sequence are the same as in FIGS. 3A and 3B. Accordingly, the only difference between the examples in FIG. 3B and FIG. 3C is that instead of detecting information about the ego-vehicle 302, the road-side unit 301 can receive it from other sources, such as from a cloud server 303.

It is to be noted, that the examples of FIG. 3A-3C can also be combined with each other, e.g., a road-side unit 301 can be equipped with its own sensors, and simultaneously, it can also receive information from other sources as well, i.e., from an ego-vehicle 302 itself, and/or from a cloud server 303.

In the following, a few exemplary use cases are described, wherein the method and system according to the invention can be used to improve road safety.

A dimension of an ego-vehicle is an important parameter for various safety applications, e.g., for adaptive cruise control (ACC), vehicle platooning, Forward Collision Warning (FCW), etc. The dimension of the ego-vehicle may also be used to support association of objects or data in messages (e.g., perception messages) with the ego-vehicle.

FIGS. 4A and 4B are showing exemplary scenarios, wherein an ego-vehicle 410 is not aware of its correct dimensions, e.g., that a trailer 411 is attached to the ego-vehicle 410. As the ego-vehicle 410 has incorrect information of its own dimensions, the actual size and/or weight is incorrectly known by the ego-vehicle 410. Therefore, certain safety applications might calculate triggering conditions based on such an incorrect data. As a result, the safety applications might miscalculate an important parameter, e.g., a time-to-collision period.

For example, a forward collision warning (FCW) application could potentially trigger late if the calculations do not take into consideration the increased braking distance that is caused by the increased weight of the ego-vehicle 410.

As a further example, inaccurate information regarding the physical dimensions of the ego-vehicle 410 could cause false negative triggers in an Intersection Movement Assist (IMA) application. If an ego-vehicle 410 broadcasts a smaller dimension value (i.e., size) than it actually has (e.g. because it is not aware of an attached trailer 411), there may be false negative triggers or a lack of warning, and certain other vehicles may not be alerted about a potential collision.

As a further example, in a highway scenario, a Blind Spot Warning (BSW) application could potentially generate a false negative trigger because of a misconfigured or incorrect parameter. Again, if e.g., a V2X unit is not aware of the attached trailer 411, the BSW application may only consider a blind spot having a smaller area than the actual area of the blind spot.

Updating a poorly configured parameter that is critical for a safety application via the method or system according to the invention can fix a misconfiguration and can ensure proper working (e.g. a correct time-to-collision calculation) of the safety application.

In the exemplary scenarios according to FIGS. 4A and 4B, the ego-vehicle 410 has a first self-describing dataset 412 that has an incorrect parameter about a dimension of the ego-vehicle 410. According to the depicted examples, the ego-vehicle 410 is not aware of a trailer 411 attached to it. Therefore, when the ego-vehicle 410 broadcasts its first self-describing dataset 412, e.g., in a form of a message 413, the message 413 is going to contain incorrect information or data about a size and/or weight of the ego-vehicle 410.

According to the example of FIG. 4A, a road-side-unit 420, which is preferably equipped with a camera, detects the ego-vehicle 410 and also receives the message 413. By comparing the received message 413 with its own detection 421, the road-side unit 420 can become aware that the ego-vehicle 410 is sending an incorrect data (an incorrect parameter value). Therefore, it sends a return perception message 422a, preferably in a form of an I2X message, notifying the ego-vehicle 410 about its detection 421. Based on the received return perception message 422a, the ego-vehicle 410 can update and fix its parameter values via the method and/or system according to the invention and create an updated self-describing dataset 414 with corrected parameter values.

FIG. 4B shows an example, wherein a road-side unit 420 sends out its detection 421 about the ego-vehicle 410, preferably in a form of a perception message 422b (e.g., an I2X message), even without a message 413 from the ego-vehicle 410. Reception of the perception message 422b can trigger the ego-vehicle 410 to correct its originally incorrect first self-describing dataset 412 to an updated self-describing dataset 414 having a corrected parameter value about the dimensions of the ego-vehicle 410.

Furthermore, if the road-side unit 420 is connected to a weighting station or any sensor that can measure a nearby vehicle's weight (e.g. with a sensor added to the pavement), the road-side unit 420 can communicate the detected weight information in a similar manner as above. This information can later be used by the ego-vehicle 410 to update its parameters of the same type through the method or system according to the invention.

The method and system according to the invention can be used in further cases, e.g., to detect conditions that directly affect the immediate safety of road users. For example, an object detection algorithm can distinguish vulnerable road users based on their equipment, thus differentiating between bicycle or motorcycle riders who are wearing helmets and/or other protective gear and those who are not. Another example could be to detect whether a passenger of a car is wearing a seatbelt during travel or not by using cameras or other devices that are widely used by traffic authorities and law enforcement. Based on detection feedback from an other entity, such as an RSU or any other vehicle, an ego-vehicle can be notified of the fact that a rider/driver/passenger is more likely to get injured in a potential accident because of the lack of protective gear or other safety precautions. This information can then be utilized in many ways. For example, the surrounding vehicles (i.e., those surrounding the potentially more vulnerable user) can prepare for any interaction with the said vehicle and take extra measures to avoid any, potentially fatal, conflicts.

On the other hand, in case there are multiple parties verifying that a rider/driver/passenger is potentially in more danger, then the ego-vehicle can warn the rider/driver of the situation, or even directly intervene and e.g., enforce a temporary speed limit until the situation is solved. Additionally, if the ego-vehicle implements a travel data recorder functionality (a.k.a. a black box), that collects input from internal/external sensors, information handled or calculated by a self-reflection unit 130 (see FIG. 2) could also be recorded. For example, this could be used for helping investigations after an accident to determine whether the ego-vehicle's internal/external sensors were perceiving the environment the same way as other vehicles. For example, a vehicle's internal sensors could log that all seatbelts were fastened, but based on a reliable external and/or independent RSU camera detection the self-reflection service could log that other parties perceived that one or more seatbelts were not fastened.

It is also to be noted that data stored about a state of certain subsystems/devices might not accurately reflect what other entities perceive about an ego-vehicle or its certain properties. This may be due to an error in said subsystems/devices or simply because a change in the environmental conditions.

For example, a tire monitor system of an ego-vehicle may suggest that there is enough pressure within the tires, but an other entity, such as an infrastructure entity can detect with e.g., a camera or other sensor that the ego-vehicle has a flat tire. The method and system according to the invention can change the ego-vehicle's understanding of the state of its tires. As a result, e.g., it can override the tire monitoring system's perception and notify the driver, and/or even declare the tire monitoring subsystem as faulty and trigger e.g., a ‘service required’ notification.

As a further example, an onboard diagnostic system of an ego-vehicle can sense that a light of a vehicle is turned on. An other entity, such as an infrastructure entity like a RSU with a traffic camera could observe said ego-vehicle and its appearance. Again, this could e.g., mean faulty subsystems or driver negligence. For example, if such an infrastructure entity can detect that e.g., in limited visibility conditions such as darkness or foggy conditions a certain ego-vehicle does not have its lights on, the infrastructure entity could send a message (e.g., an I2X message) with the information that the lights are not visible to external entities, it seems that they are not turned on. With the help of the method according to the invention, the ego-vehicle's onboard diagnostic system could e.g., run a special diagnostic routine. A notification could be shown for the driver to check whether the lights are truly turned on.

In some countries/regions, it is regulated by legislation that license plates must be in good condition and must be visible at all times. If an ego-vehicle (for example an SUV-type ego-vehicle) with its back completely covered in mud enters a rural road from a dirt road segment, an infrastructure entity could detect with e.g., a camera sensor that neither the license plate nor the backlights are visible from behind. The infrastructure entity could send a message (preferably an I2X message) to the SUV-type ego-vehicle about this condition and then the SUV-type ego-vehicle could notify the driver to stop, clean the back of the car, and solve the potentially dangerous/irregular state.

As a further example, an emergency vehicle equipped with a V2X system might also be misconfigured. Normally, when such an emergency vehicle is operating its siren and/or special flashing lights (light bar), it simultaneously can broadcast a message about it, preferably in a form of a specialized emergency vehicle extension like in the BSM message format. However, if such an emergency vehicle is operating its siren and special flashing lights (light bar), but for some reason not broadcasting it, then an infrastructure entity can detect this inconsistency and send a message (preferably an I2X message) with information about this perception. Via performing the method according to the invention, the emergency vehicle can check its V2X system and reconfigure any necessary settings to solve the issue.

In the above example, just like in FIG. 3B, an RSU can detect the presence and the state of the emergency vehicle and broadcast this information to the emergency vehicle and also to other traffic participants to further enhance traffic safety.

The method and system according to the invention are not only capable of adjusting crucial parameters of a working system but can also, for example, help in configuring new instalments. In some cases, V2X-based solutions for vehicles are aftermarket products, i.e., are not pre-installed by a vehicle's original equipment manufacturer (OEM). Therefore, applying V2X-based solutions to older vehicles, or vehicles that are not already equipped with V2X technology, initializing of a new device can be time-consuming since configuration of the device must be done on a per device basis.

For example, the method and system according to the invention could be used to decrease the cost and time to retrofit a vehicle with an OBU (an on-board V2X unit). Retrofitted OBUs could be simply installed with a generic configuration, e.g., which is not specific to the host vehicle in every available parameter/detail, therefore potentially saving both time and money during the development and/or installation processes. The newly installed OBU could, for example, be configured with a “calibrating period”, wherein information about the host vehicle (ego-vehicle) is preferably gathered from incoming V2X messages and using the method and/or system according to the invention. With the help of the method and/or system according to the invention the OBU can perform the necessary parameter configuration without a need for intervention of special technical personnel.

The method and system according to the invention can also be used for a perception message-aided map-matching, i.e., for correcting location-information of an ego-vehicle based on information originating from an other entity, such as an infrastructure entity, e.g., an RSU. Geo-localizing or map-matching of an ego-vehicle is not an easy task. However, a road-side unit 301 of FIGS. 3A-3C can also help the ego-vehicle to get a more precise position information to map-match itself. If a road-side unit 301 is connected to sensors in a pavement of a road or have other types of sensors focused to a single lane of a road, then a precise position (lane information) of an ego-vehicle can be detected and forwarded to the ego-vehicle being in that position. The ego-vehicle can use this position-information to enhance or correct its own position-information. So, although a position of an ego-vehicle can be considered a frequently changing parameter of the ego-vehicle, the method and system according to the invention can contribute to correct or enhance such type of information about the ego-vehicle.

As an example, if an ego-vehicle is traveling with inaccurate HD (high-definition) map details, it might mismatch itself and might use a wrong lane during map-matching. If an infrastructure entity detects this ego-vehicle with high certainty, the infrastructure entity can send a precise lane information observed by the infrastructure entity to the ego-vehicle, and the ego-vehicle can use this information to update its own lane information. An RSU as an infrastructure entity can be aware of its environment and the lanes its sensors (e.g., its camera) is observing. For example, a service can exist that allows engineers or an automated procedure to set lanes and even more precise location information on that lane with respect to SD and HD maps. Once the ego-vehicle is within the range of the sensor of the infrastructure entity, the infrastructure entity can send a message (e.g., an I2X message preferably via a viable medium for V2X communications) to the ego-vehicle that contain a segment of the road and lane that the ego-vehicle is travelling on with an exact perceived location.

To increase accuracy and reliability, the message from the infrastructure entity can also contain an identification of a previous and a next road segment as well. For example, for an ego-vehicle travelling on a highway at 36 m/s speed in the rightmost lane, an RSU connected to a camera detecting the ego-vehicle could send the following information to the vehicle: 1) a perceived position of the ego-vehicle, 2) a precise time of the detection, 3) a perceived trajectory information, i.e., a precise detected lane position information for a time period (e.g., for the last 0.2 s, which is in this case a 7.2 m long trajectory) with respect to a timestamp recorded in the message, 4) a predicted trajectory, i.e., a precise predicted lane position information for an upcoming time period (e.g., for a following 0.2 s, which is in this case a 7.2 m trajectory) with respect to the timestamp recorded in the message, 5) any additional information that helps the ego-vehicle to associate the subject of the message with itself.

This procedure can utilize map and position representations/types of any of the available map providers. The choice of the used representation could also depend on a preference of a target vehicle, if there is no regulatory obligation e.g., due to a standard or legislation.

An advantage of the procedure described above is that an ego-vehicle can increase/correct its position accuracy by utilizing perception input that is received via a regular V2X or I2X message. It is also to be noted, that with the help of the method and system according to the invention, an ego-vehicle can reliably determine its own position or any other parameter even without any prior information about it. Therefore, it is also possible to map-match itself and also to use the map-matched information to update its internal systems and parameter values.

As discussed above, road-side units or other infrastructure entities can take part in enhancing the positioning of vehicles. A straightforward method to do so is to use an RTCM message. The RTCM is a standardized message type that contains GNSS augmentation information which helps GNSS receivers at a given location to improve their geolocation by mitigating localization errors caused by the stratosphere and other effects that impact the signal traveling between the satellites and the receiver. Road-side units can also send messages like a CPM (Collective Perception Message, a V2X-based sensor sharing service), a MAP (Map Data Message, a frequently used message type describing a geometry of an intersection or a road segment, e.g., information about lane(s) direction in one specific intersection), and a SPaT (Signal Phase and Timing, describing a current phase at a signalized intersection, together with a residual time of the current phase, preferably for every lane and allowing e.g., GLOSA-Green Light Optimal Speed Advisory) message, which are all absolute geolocation-based services.

An advantage of using an RSU as an information source is that an RSU preferably has a well-defined position, and normally it also has a better sensing configuration (from a higher position and/or with less likelihood of having a blocked or obstructed line of sight). It is important for providing a high-quality service by the RSU that its location needs be known very accurately. The global position of the RSU is a typical constant configuration parameter. Problems may arise, however, if an RSU is deployed and correctly configured in a certain place, e.g., on a pole, but, for some reason, road workers move the pole without a proper reconfiguration of the RSU. Other realistic causes of dislocation may arise due to a significant tectonic movement; a location of items can change over time, which could even be a few centimeters per year.

An automatic solution to this problem is to attach a Real-time Kinematic (RTK) unit as local sensor to the RSU, as an RTK unit is a highly precise GNSS-based localization unit that continuously updates its absolute position. Therefore, the RSU can automatically update its absolute position information using the RTK unit. The method according to the invention can also be used by the RSU to detect and correct any misbehaviour of the RTK unit.

The invention, furthermore, relates to a computer program product comprising instructions which, when the program is executed by a computer, cause the computer to carry out an embodiment of the method according to the invention.

The computer program product may be executable by one or more computers.

The invention also relates to a computer readable medium comprising instructions which, when executed by a computer, cause the computer to carry out an embodiment of the method according to the invention.

The computer readable medium may be a single one or comprise more separate pieces.

The invention is, of course, not limited to the preferred embodiments described in detail above, but further variants, modifications and developments are possible within the scope of protection determined by the claims. Furthermore, all embodiments that can be defined by any arbitrary dependent claim combination belong to the invention.

### List of Reference Signs

101 incoming data
105 V2X communication unit
110 data association unit
120 database
121 remote data
122 infrastructure data
123 ego-data
124 parameter update
125 ego-storage
126 remote-storage
127 map-storage
130 self-reflection unit
210 data prefilter module
211 parameter selection module
212 scene analyser unit
213 first decision-making unit
220 parameter estimation module
22 parameter estimate
222 quality indicator value
230 quality checker module
231 second decision-making unit
240 configuration module
410 ego-vehicle
411 trailer
412 first self-describing dataset
413 message
414 updated self-describing dataset
420 road-side unit
421 detected parameter
422a return perception message
422b perception message

1. A method for correcting a self-describing dataset of an ego-vehicle, wherein the self-describing dataset comprises parameter values of the ego-vehicle's vehicle parameters and/or vehicle states, the method comprising
a data collection step including
receiving, by the ego vehicle, a message from an other entity, and
extracting, by the ego-vehicle, ego-vehicle related data from the message, wherein the extracted ego-vehicle related data includes at least one parameter value of any one of the ego-vehicle's vehicle parameters and/or vehicle states,
a data verification step including
determining, by the ego-vehicle, a reliability score of the extracted ego-vehicle related data, and
if the reliability score of the extracted ego-vehicle related data is above a predetermined reliability threshold, comparing the extracted ego-vehicle related data with a corresponding parameter value of the self-describing dataset, and if the corresponding parameter value of the self-image is incorrect, updating, in a parameter updating step, the corresponding parameter value of the self-describing dataset with the extracted ego-vehicle related data.

2. The method according to claim 1, wherein the other entity is a road-side unit.

3. The method according to claim 1, wherein in the data collection step, messages are received from one or more other entities, and in the data verification step said messages are considered for determining the reliability score.

4. The method according to claim 1, wherein the verification step further includes a scene analysing step, performed by a scene analyser unit, for analysing measurement conditions and a result of the scene analysing step is considered for the determination of the reliability score.

5. The method according to claim 4, wherein the measurement conditions include at least one of the following: a sensor type, a view angle, a weather condition, a visibility condition, a relative position of the ego-vehicle and the other entity, and an occlusion possibility.

6. The method according to claim 1, further comprising a step of, sending a message to the other entity comprising a parameter value of the self-describing dataset and request to sending back a return message comprising information in connection with the sent parameter value of the self-describing dataset.

7. The method according to claim 1, further comprising storing the extracted ego-vehicle related data in a database.

8. The method according to claim 1, further comprising storing extracted data having a quality indicator value above a predetermined threshold in a database.

9. The method according to claim 1, wherein the message is a V2X message or an I2X message.

10. A system for correcting a self-describing dataset of an ego-vehicle comprising
an ego-vehicle implementing the method according to claim 1, and
an other entity adapted to send a message to the ego-vehicle.

11. The system according to claim 10, wherein the other entity is a road-side unit.

12. The system according to claim 10, wherein the ego-vehicle comprises a communication unit for receiving a message from the other entity.

13. The system according to claim 10, wherein the ego-vehicle comprises a data extraction unit for extracting ego-vehicle related data from the message, wherein the extracted ego-vehicle related data includes at least one parameter value of any one of the ego-vehicle's vehicle parameters and/or vehicle states.

14. The system according to claim 13, wherein the ego-vehicle comprises a verification unit connected to the data extraction unit, wherein the verification unit is configured to determine a reliability score of the extracted ego-vehicle related data.

15. The system according to claim 14, wherein the ego-vehicle comprises a scene analyser unit for analysing measurement conditions, wherein an output of the scene analysing unit is fed to the verification unit to be considered for the determination of the reliability score.

16. The system according to claim 15, wherein the measurement conditions include at least one of the following: a sensor type, a view angle, a weather condition, a visibility condition, a relative position of the ego-vehicle and the other entity, and an occlusion possibility.

17. The system according to claim 10, wherein the message is a V2X message or an I2X message.

18. A non-transitory computer program product comprising instructions which, when the program is executed by a computer, cause the computer to carry out the method of claim 1.

19. A non-transitory computer readable medium comprising instructions which, when executed by a computer, cause the computer to carry out the method of claim 1.
